(19) United States
(12) Patent Application Publication
(10) Pub. No.: US 2026/0010866 A1
(43) Pub. Date: Jan. 8, 2026

(54) METHOD AND PROCESSING UNIT FOR MANAGING INVENTORY OF PRODUCTS WITH MULTI-STAGE MANUFACTURING SYSTEM

(71) Applicant: Sameer Garg, Chicago, IL (US)

(72) Inventor: Sameer Garg, Chicago, IL (US)

(21) Appl. No.: 18/764,216

(22) Filed: Jul. 4, 2024

(51) Int. Cl. G06Q 10/087; G06Q 30/0202; G06Q 50/04

(52) U.S. Cl. CPC G06Q 10/087; G06Q 30/0202; G06Q 50/04

(57) ABSTRACT

The present invention discloses a method to manage inventory of products with multi-stage manufacturing system. The method comprises receiving a demand pattern associated with products. The demand pattern includes revenue data and volatility data associated with the products. Further, the method includes labeling the products with demand factors and volatility factors based on the retrieved demand pattern. Furthermore, the method includes generating a Two-Dimensional (2D) grid placed within the 2D grid based on the labeling. The 2D grid comprises a dimension associated with the demand factors and another dimension associated with the volatility factors. Moreover, the method includes classifying the plurality of products to be assembled to order and made to order based on the placement of the products within the grid. Additionally, the method includes determining quantity parameters of the plurality of products based on the classification, to manage inventory of the plurality of products.

### FIELD OF THE PRESENT INVENTION

Embodiments of the present invention generally relate to managing inventory of products. In particular, embodiments of the present invention relate to a method and a processing unit for managing inventory of products associated with multi-stage manufacturing system, based on revenue data and volatility data related to the product.

### BACKGROUND OF THE DISCLOSURE

Effective inventory management is pivotal in meeting customer demands promptly. It ensures that a business maintains adequate stock levels and promptly identifies shortages to fulfill customer needs. Lead time, particularly in manufacturing, encompasses the duration from order initiation to final delivery, influencing customer satisfaction and obsolescence risks. Shorter lead times enhance customer satisfaction and mitigate obsolescence concerns.

Optimizing inventory management significantly impacts lead time reduction. Traditional methods often rely on revenue or sales volume, occasionally incorporating historical lead times. However, these approaches may overlook seasonal or volatility considerations, leading to inefficient stocking practices. For instance, products with moderate demand but high volatility may not warrant extensive stocking due to potential shelf-life concerns. Relying solely on revenue or sales data can exacerbate inventory discrepancies when actual demand deviates from predictions, resulting in unnecessary expenses and resource allocation.

Moreover, complex products, assembled from multiple components across various manufacturing stages, pose additional inventory management challenges. Conventional systems fail to address these multi-stage manufacturing processes adequately. For instance, in semiconductor manufacturing, inventory management often neglects component-specific considerations, such as die-to-chip ratios. Similarly, for products like compressors, inventory systems overlook the interdependence between the final product and its constituent components, like piping and coils.

Thus, there arises a necessity for an inventory management methodology and processing unit tailored to multi-stage manufacturing systems. Such a system should not only consider revenue but also factor in the volatility associated with both the final product and its components.

The information disclosed in this background of the disclosure section is only for enhancement of understanding of the general background of the disclosure and should not be taken as an acknowledgment or any form of suggestion that this information forms existing information already known to a person skilled in the art.

### BRIEF SUMMARY OF THE DISCLOSURE

A method, a processing unit, and a non-transitory computer-readable medium for managing inventory of products with multi-stage manufacturing system. To manage the inventory, initially, a demand pattern associated plurality of products is received. The demand pattern comprises at least one of revenue data and a volatility data associated with each of the plurality of products. Further, each of the plurality of products is labeled to be associated with one of demand factors and one of volatility factors based on the received demand pattern. Based on the labeling, a Two-Dimensional (2D) grid with the plurality of products placed within the 2D grid is generated. The 2D grid comprises a dimension associated with the demand factors and another dimension associated with the volatility factors. Further, each of the plurality of products are classified to be one of assemble to order and make to order, based on the placement of the plurality of products within the grid. Quantity parameter of each of the plurality of products is determined based on the classification, to manage inventory of the plurality of products.

In a non-limiting embodiment, the revenue data indicates at least one of monetary value and quantity value of sales associated with the plurality of products over a first predefined period of time.

In a non-limiting embodiment, the volatility data indicates risk related to stocking up of the plurality of products in an inventory. The volatility data is computed by dividing standard deviation of a sold quantity of each of the plurality of products with mean of the sold quantity, wherein the sold quantity is measured for a second predefined period of time.

In a non-limiting embodiment, predefined threshold are set for the demand pattern to define the demand factors and the volatility factors, wherein the demand factors is defined to be low demand, medium demand, and high demand, and the volatility factors is defined to be low volatility, medium volatility, and high volatility.

In a non-limiting embodiment, the quantity parameter of the product and the one or more components are determined by setting the quantity parameter to be zero for one or more products classified as the make to order and setting the quantity parameter to be a predefined value for one or more products classified as the assemble to order, based on the demand factors and the volatility factors.

In a non-limiting embodiment, the quantity parameter are set to be the predefined value for the one or more products classified as the assemble to order by setting the quantity parameter to be highest for the one or more products labelled as the high demand and the low volatility.

In a non-limiting embodiment, the quantity parameter of at least one of the plurality of products are modified based on current state of the inventory, wherein the quantity parameter may be one of reduced and increased based on the current state.

In a non-limiting embodiment, the plurality of products comprising an end-product and one or more components associated with the end-product.

In a non-limiting embodiment, the plurality of products are associated with a two-stage manufacturing system. A first stage of the two-stage manufacturing system comprises manufacturing of the one or more components and a second stage of the two-stage manufacturing system comprises assembling the one or more components to output the end-product.

The features and advantages of the subject matter hereof will become more apparent in light of the following detailed description of selected embodiments, as illustrated in the accompanying FIGUREs. As one of ordinary skill in the art will realize, the subject matter disclosed herein is capable of modifications in various respects, all without departing from the scope of the subject matter. Accordingly, the drawings and the description are to be regarded as illustrative.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, features are identified by reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates an exemplary environment with a processing unit for managing inventory of products with multi-stage manufacturing system, in accordance with an embodiment of the present invention;

FIG. 2 illustrates a detailed block diagram showing functional modules of a processing unit for managing inventory of products with multi-stage manufacturing system, in accordance with an embodiment of the present invention;

FIGS. 3A-3F show exemplary embodiments for managing inventory of products with multi-stage manufacturing system, in accordance with an embodiment of the present invention;

FIG. 4 is an exemplary process of processing unit for managing inventory of products with multi-stage manufacturing system, in accordance with an embodiment of the present invention; and

FIG. 5 illustrates an exemplary computer unit in which or with which embodiments of the present invention may be utilized.

### DETAILED DESCRIPTION OF THE EMBODIMENTS

The detailed description set forth below in connection with the appended drawings is intended as a description of exemplary embodiments in which the presently disclosed invention can be practiced. The term “exemplary” used throughout this description means “serving as an example, instance, or illustration,” and should not necessarily be construed as preferred or advantageous over other embodiments. The detailed description includes specific details to provide a thorough understanding of the presently disclosed invention. However, it will be apparent to those skilled in the art that the presently disclosed invention may be practiced without these specific details. In some instances, well-known structures and devices are shown in block diagram form in order to avoid obscuring the concepts of the presently disclosed invention.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and/or firmware.

Embodiments of the present invention may be provided as a computer program product, which may include a non-transitory, machine-readable storage medium tangibly embodying thereon instructions, which may be used to program the computer (or other electronic devices) to perform a process. The machine-readable medium may include but is not limited to, fixed (hard) drives, semiconductor memories, such as Read Only Memories (ROMs), Programmable Read-Only Memories (PROMs), Random Access Memories (RAMs), Erasable PROMs (EPROMs), Electrically Erasable PROMs (EEPROMs), flash memory or other types of media/machine-readable medium suitable for storing electronic instructions (e.g., computer programming code, such as software or firmware).

Various methods described herein may be practiced by combining one or more non-transitory, machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Embodiments of the present invention relate to a method, a processing unit, and a non-transitory computer-readable medium for managing inventory of plurality of products associated with multi-stage manufacturing system. The proposed system and method aim to efficiently manage inventory by overseeing both the end-products and their various components. In addition to traditional metrics like revenue and sales, the proposed method also takes into account volatility factors to enhance inventory management. By analyzing these factors, products are categorized as either “assemble to order” or “make to order,” streamlining inventory operations. Furthermore, utilizing the current status and classification, the method includes to calculate the optimal quantity parameters for each product, simplifying the inventory process.

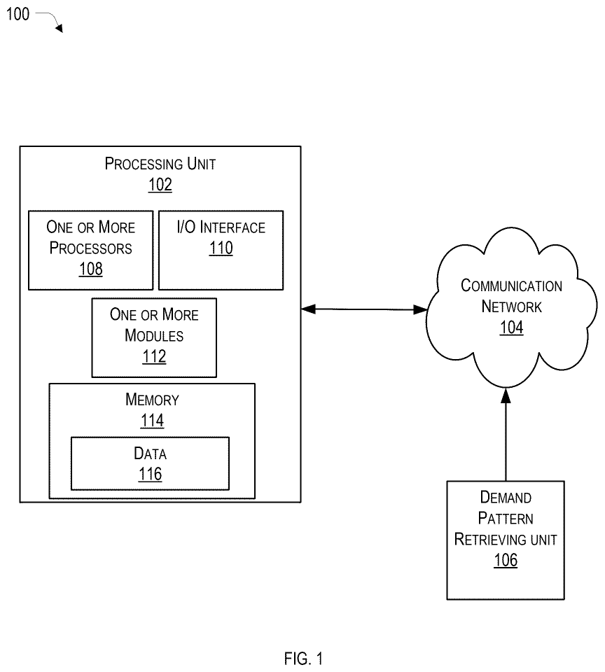

FIG. 1 illustrates an exemplary environment 100 with processing unit 102 for managing inventory of the products associated with multi-stage manufacturing system, in accordance with an embodiment of the present invention. As shown in FIG. 1, the exemplary environment 100 comprises the processing unit 102, a communication network 104, and a demand pattern retrieving unit 106. In an embodiment, the exemplary environment 100 may be integral part of computing systems or servers associated with an enterprise associated with the products. In an embodiment, the enterprise may be an industry which sells off-the shelf products (also referred to as the end-products) and its components. At least one off-the shelf product along with its components may be herein referred to as the plurality of products. In an embodiment, the enterprise may also be the manufacturer of the off-the shelf product and its components and has a requirement to manage the inventory of the plurality of products. In an embodiment, the enterprise may be a marketer, seller, or a retailer of the plurality of products and has a requirement to manage the inventory of the plurality of products. The off-the shelf product may be an end-product which constitutes at least one or more components. For example, the off-the shelf product may be a vacuum cleaner and its components may include, but is not limited to, a fan blade, electric motor, exhaust port, vacuum filters, vacuum fan, and so on. Consider the enterprise is related to a semi-conductor industry and the off-the shelf product may be a system-on-chip. The one or more components of the system-on-chip may include, but is not limited to, graphics processor, memory, USB controller, power management circuits, wireless radios and so on. In an embodiment, the plurality of products may be associated with a two-stage manufacturing system. The first stage of the two-stage manufacturing system comprises manufacturing of the one or more components and a second stage of the two-stage manufacturing system comprises assembling the one or more components to output the end-product.

The proposed processing unit 102 in the exemplary environment 100 is configured to manage the inventory of the plurality of products. The processing unit 102 may communicate with the demand pattern retrieving unit 106, associated with the enterprise, to manage the inventory of the plurality of products. In an embodiment, the processing unit 102 may be connected with the demand pattern retrieving unit 106, via the communication network 104. The communication network 104 may include, without limitation, a direct interconnection, a Local Area Network (LAN), a Wide Area Network (WAN), a wireless network (e.g., using Wireless Application Protocol), the Internet, and the like. The processing unit 102, in communication with the demand pattern retrieving unit 106, may be configured to manage the inventory of the plurality of products and output a quantity parameter associated with each of the plurality of products. The quantity parameter may indicate if each of the plurality of products is to be assembled to order or to be made to order and quantity indicates how much is to be assembled and how much is to be made.

The demand pattern retrieving unit 106 may be configured to retrieve the demand patterns associated with each of the plurality of products and provide the demand pattern to the processing unit 102 for managing the inventory of the plurality of products. The inventory of the plurality of products is significantly managed using the demand pattern received from the demand pattern retrieving unit 106. In an embodiment, the demand pattern retrieving unit 106 may be embedded with a user device associated with a user related to the enterprise. In an embodiment, the user device may be, but is not limited to, at least one of a smartphone, a head-mounted device, smart glasses, a television, a PC, a tablet, a laptop, and so on. In an embodiment, the user may be a person or employee of the enterprise, who may be responsible or may be managing the inventory of the plurality of products for the enterprise. In an embodiment, the demand pattern may be inputted by the user. In another embodiment, the demand pattern may be automatically computed by the demand pattern retrieving unit 106 using a pre-stored or pre-fed set of information associated with the plurality of products and the enterprise. In an embodiment, the set of information may be related to, but is not limited to, a monetary value of sales, revenues, a quantity of sales, and so on related to the plurality of products. In an alternate embodiment, the demand pattern retrieving unit 106 may be integral part of the processing unit 102.

In an embodiment, the processing unit 102 may be configured to manage the inventory upon receiving a request. In an embodiment, the request may be manually provided by the user. In an embodiment, when providing the request, the user may be prompted to select one or more products for which the inventory is to be managed. In an embodiment, the request may trigger to manage the inventory of all products associated with the enterprise. In an embodiment, the request may be auto-generated. The auto-generation of the request may be scheduled. For example, the request to manage the inventory of the plurality of products may be generated once every month, every year, half year, or quarter of a year, for the enterprise. The schedule of the request may depend on operations of the enterprise and need for the inventory management of the enterprise. In such an embodiment, the processing unit 102 may be configured to auto-generate the request when a shortage of a product amongst the plurality of products is detected within the inventory. Further, in such an embodiment, the processing unit 102 may be configured to the auto-generate the request when an unsold stock of products is detected within the inventory. One or more other triggers, known to a person skilled in the art, may be used by the processing unit 102, to auto-generate the trigger.

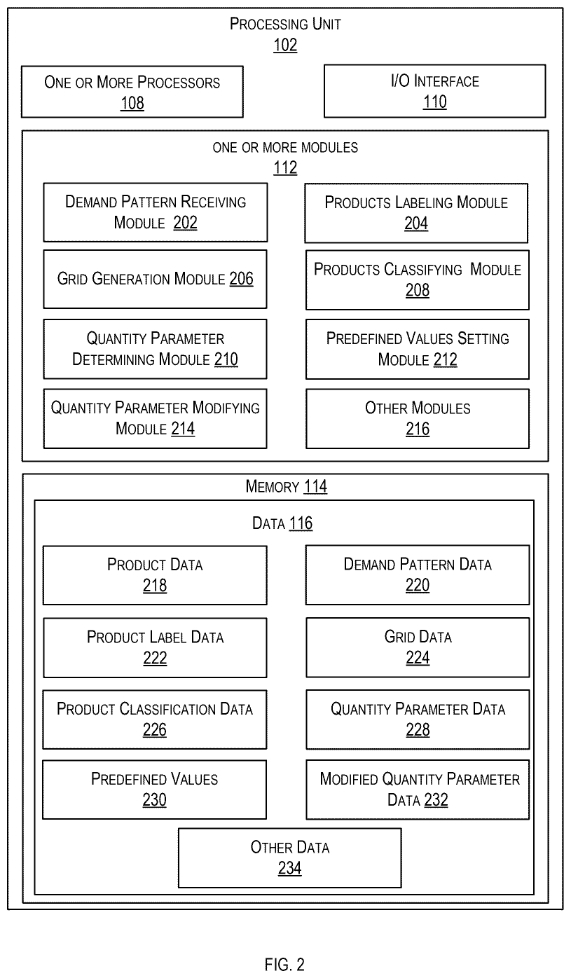

FIG. 2 shows a detailed block diagram of the processing unit 102 for managing the inventory of the plurality of products, in accordance with some non-limiting embodiments or aspects of the present disclosure. The processing unit 102 may include one or more processors 108, an Input/Output (I/O) interface 110, one or more modules 112, and a memory 114. In some non-limiting embodiments or aspects, the memory 114 may be communicatively coupled to the one or more processors 108. The memory 114 stores instructions, executable by the one or more processors 108, which on execution, may cause the processing unit 102 to manage the inventory of the plurality of products. In some non-limiting embodiments or aspects, the memory 114 may include data 116. The one or more modules 112 may be configured to perform the steps of the present disclosure using the data 116 to manage the inventory of the plurality of products. In some non-limiting embodiments or aspects, each of the one or more modules 112 may be a hardware unit, which may be outside the memory 114 and coupled with the processing unit 102. In some non-limiting embodiments or aspects, the processing unit 102 may be implemented in a variety of computing systems, such as a laptop computer, a desktop computer, a Personal Computer (PC), a notebook, a smartphone, a tablet, e-book readers, a server, a network server, a cloud server, and the like. In a non-limiting embodiment, each of the one or more modules 112 may be implemented with a cloud-based server, communicatively coupled with the processing unit 102.

The data 116 in the memory 114 and the one or more modules 112 of the processing unit 102 are described herein in detail. In one implementation, the one or more modules 112 may include but is not limited to, a demand pattern receiving module 202, a products labeling module 204, a grid generation module 206, a products classifying module 208, a quantity parameter determining module 210, a predefined values setting module 212, a quantity parameter modifying module 214, and one or more other modules 216 associated with the processing unit 102. In some non-limiting embodiments or aspects, the data 116 in the memory 114 may include product data 218, demand pattern data 220 (herewith also referred to as demand pattern 220), product label data 222, grid data 224, product classification data 226, quantity parameter data 228 (herewith also referred to as quantity parameter 228), predefined value 230, modified quantity parameter data 232 (herewith also referred to as modified quantity parameter 232), and other data 234 associated with the processing unit 102.

In some non-limiting embodiments or aspects, the data 116 in the memory 114 may be processed by the one or more modules 112 of the processing unit 102. In some non-limiting embodiments or aspects, the one or more modules 112 may be implemented as dedicated units and when implemented in such a manner, the modules may be configured with the functionality defined in the present disclosure to result in novel hardware. As used herein, the term module may refer to an Application Specific Integrated Circuit (ASIC), an electronic circuit, Field-Programmable Gate Arrays (FPGA), a Programmable System-on-Chip (PSoC), a combinational logic circuit, and/or other suitable components that provide the described functionality. The one or more modules 112 of the present disclosure function to manage the inventory of the plurality of products. The one or more modules 112 along with the data 116, may be implemented in any system within any enterprise for managing the inventory of the plurality of products.

In an embodiment, the processing unit 102 may be configured to function for a dedicated enterprise and manage the inventory of the plurality of products associated with that enterprise. In an embodiment, the processing unit 102 may be associated with multiple enterprises. In such an embodiment, the processing unit 102 may be configured to receive data related to the plurality of products of each of the multiple enterprises and manage the inventory for corresponding enterprise. In an embodiment, each of the multiple enterprises may be associated with corresponding demand pattern retrieving 106. In an alternate embodiment, a single demand pattern retrieving 106 may be implemented to retrieve demand pattern 220 of all the products related to the multiple enterprises.

For managing the inventory, the demand pattern receiving module 202 of the processing unit 102, may be configured to receive the demand pattern 220 associated with the plurality of products. The demand pattern 220 may be received from the demand pattern retrieving unit 106. The demand pattern 220 includes at least one of revenue data and a volatility data associated with each of the plurality of products. In an embodiment, the revenue data indicates at least one of monetary value and quantity value of sales associated with each of the plurality of products over a first predefined period of time. In an embodiment, the first predefined period of time may be defined to be one of one year, two years, three years, four years, or five years prior to generation of the request for managing the inventory. In an embodiment, the volatility data indicates risk related to stocking up of the plurality of products in an inventory. The volatility data may be computed by dividing standard deviation of a sold quantity of each of the plurality of products with mean of the sold quantity. The sold quantity may be measured for a second predefined period of time. In an embodiment, the second predefined period of time may be defined to be one of one year, two years, three years, four years, or five years prior to generation of the request for managing the inventory. In an embodiment, the demand pattern 220 may be dynamically computed upon receiving the request for the inventory management. In another embodiment, the demand pattern 220 may be computed and stored in a database associated with the enterprise, prior to the generation of the request. In such an embodiment, the demand pattern 220 may be periodically computed and stored in the database. By periodically computing the demand pattern 220, latest information regarding the plurality of products is included in the demand pattern 220.

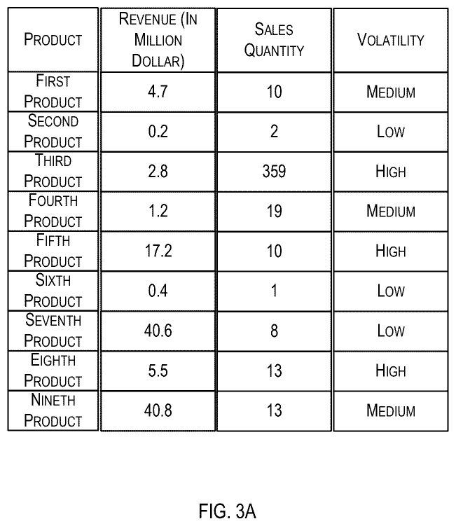

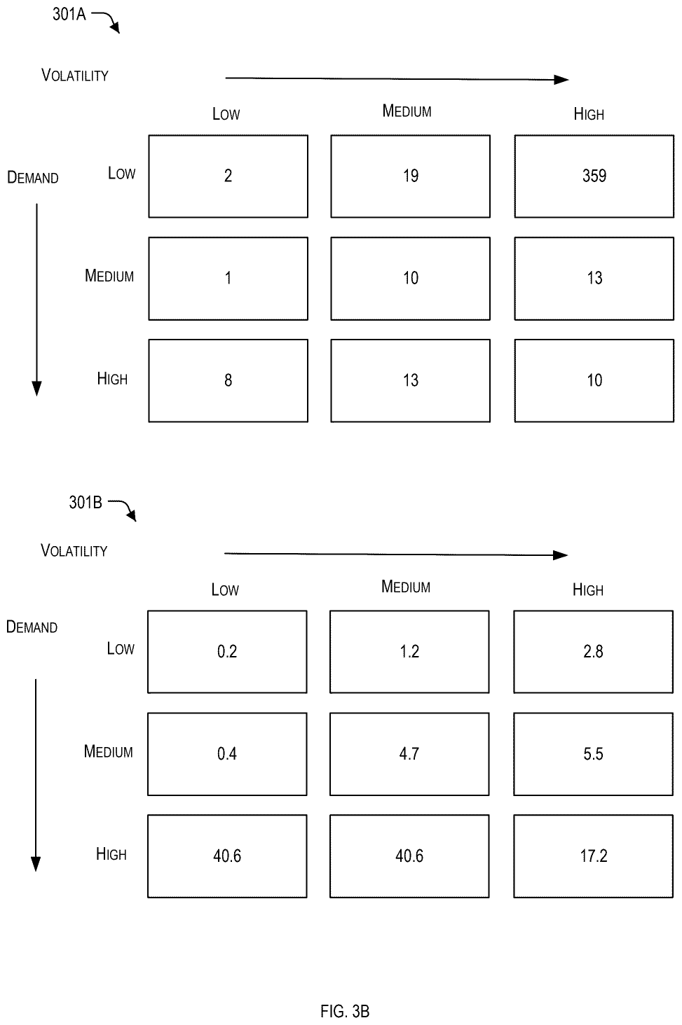

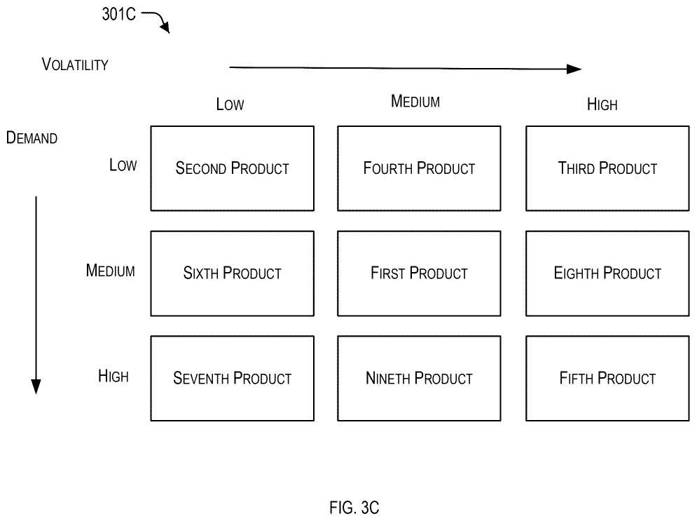

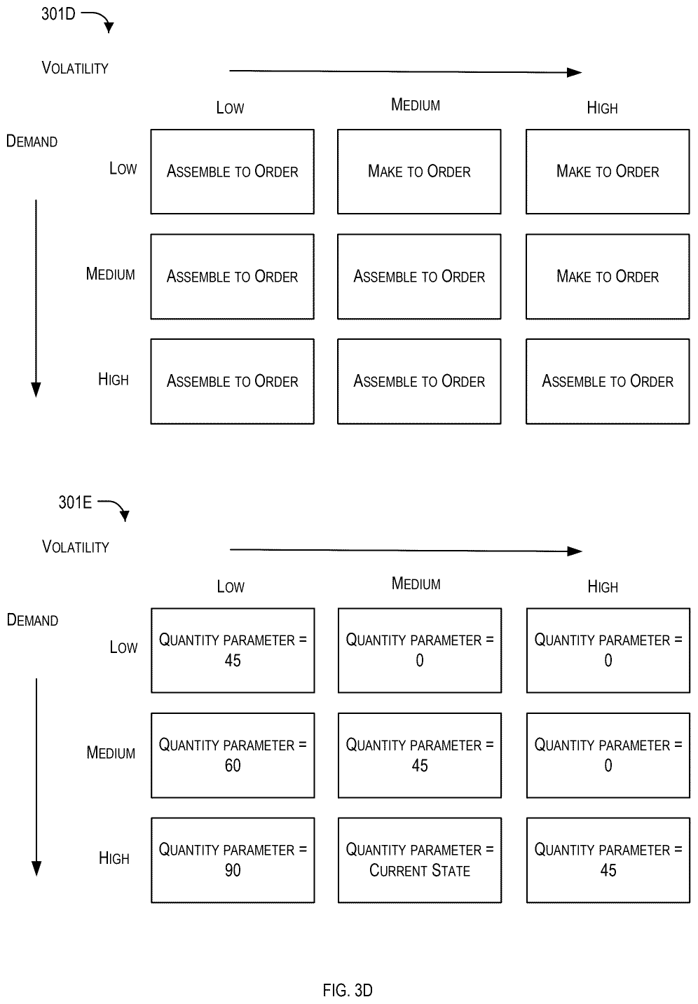

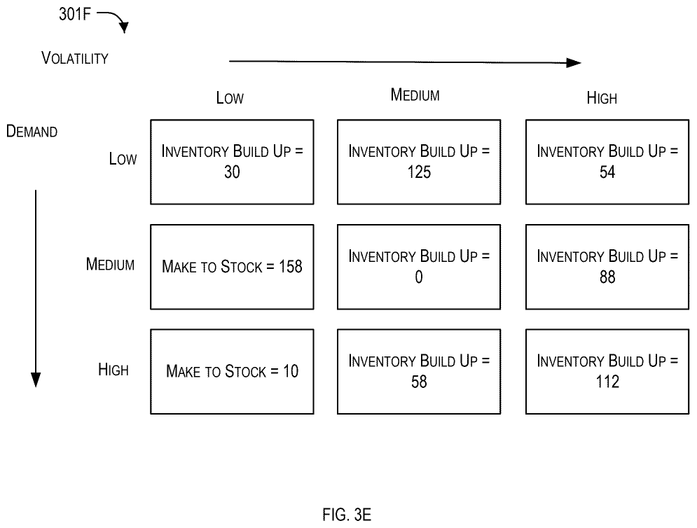

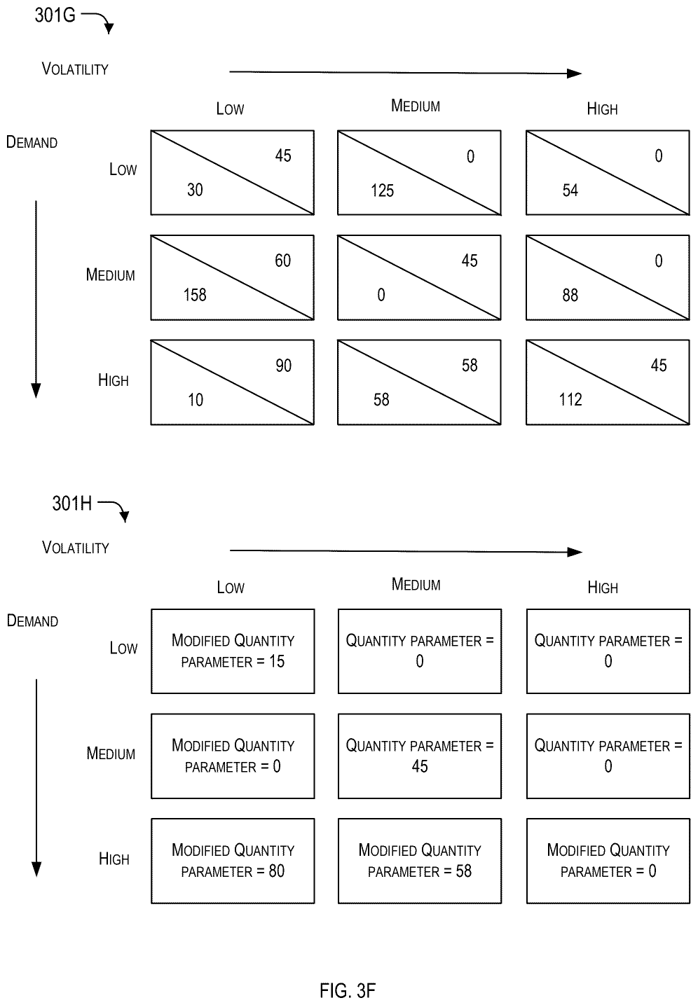

An exemplary representation of the demand pattern 220 of the plurality of products is shown in the FIG. 3A. Consider the plurality of products include a first product, a second product, a third product, a fourth product, a fifth product, a sixth product, a seventh product, an eight product, and the ninth product. In an embodiment, information or data related to the plurality of products associated with the enterprise may be stored as the product data 218. The demand pattern 220 in the exemplary representation includes revenue generated, sales generated, and volatility associated with each of the plurality of products. The revenue generated indicates revenue generated by each of the plurality of products in million dollars. The sales quantity indicates exact quantity of units sold for the second predefined period of time. The volatility is represented to be one of high, medium, or low. The volatility of each product may be selected to be one of low, medium, or low based on values of the sales quantity.

Upon receiving the demand pattern 220, the products labeling module 204 of the processing unit 102 may be configured to label each of the plurality of products to be associated with one of demand factors and one of volatility factors based on the retrieved demand pattern 220. In an embodiment, like the volatility factors (as shown in FIG. 3A), the demand factors may also include high, medium, and low. In an embodiment, the demand factor for each of the plurality of products may be selected to be one of high, medium, or low based on the revenue of the corresponding product. In another embodiment, the demand factor for each of the plurality of products may be selected to be one of high, medium, or low based on the sales quantity of the corresponding product. In an embodiment, the demand factor for each of the plurality of products may be selected to be one of high, medium, or low based on both the revenue and the sales quantity of the corresponding product. In an embodiment, predefined threshold for the demand pattern 220 may be set to define the demand factors and the volatility factors. For example, a product associated with the revenue greater than 40 million dollars may be defined to be associated with high demand value. In an embodiment, the predefined threshold may be in form of a range. In an embodiment, the labels provided to each of the plurality of products are stored as the product label data 222 in the memory 114.

Further, the grid generation module 206 of the processing unit 102 may be configured to generate a 2D grid with the plurality of products placed within the 2D grid based on the labeling. The 2D grid comprises a dimension associated with the demand factors and another dimension associated with the volatility factors. Exemplary representations of the 2D grid is shown in FIG. 3B and FIG. 3C. A first grid 301A in FIG. 3B shows placement of the plurality of products where the demand factors are selected based on the sales quantity. A second grid 301B in FIG. 3B shows placement of the plurality of products where the demand factors are selected based on the revenue. Final grid with placement of the plurality of products is shown as a third grid 301C in FIG. 3C. In an embodiment, when two or more products are associated with similar demand and volatility factor, the two or more products may be placed within corresponding cell of the 2D grid. In an embodiment, if no product is associated with a particular demand and volatility factor, corresponding cell may be left blank.

The products classifying module 208 of the processing unit 102 may be configured to classify each of the plurality of products to be one of assemble to order and make to order, based on the placement of the plurality of products within the grid. In an embodiment, a product associated with low volatility factor and low demand factor may be classified to be associated with assemble to order. In an embodiment, a product associated with low volatility factor and medium demand factor may be classified to be associated with assemble to order. In an embodiment, a product associated with low volatility factor and high demand factor may be classified to be associated with assemble to order. In an embodiment, a product associated with medium volatility factor and low demand factor may be classified to be associated with make to order. In an embodiment, a product associated with medium volatility factor and medium demand factor may be classified to be associated with assemble to order. In an embodiment, a product associated with high volatility factor and high demand factor may be classified to be associated with assemble to order. In an embodiment, a product associated with high volatility factor and low demand factor may be classified to be associated with make to order. In an embodiment, a product associated with high volatility factor and medium demand factor may be classified to be associated with make to order. In an embodiment, a product associated with high volatility factor and high demand factor may be classified to be associated with assemble to order. An exemplary presentation of the third grid 301C, upon the classification is shown as fourth grid 301D in FIG. 3D. Upon the classification, the first product is classified as assemble to order, the second product is classified as assemble to order, the third product is classified as make to order, the fourth product is classified as make to order, the fifth product is classified as assemble to order, the sixth product is classified as assemble to order, the seventh product is classified as assemble to order, the eighth product is classified as make to order and the ninth product is classified as assemble to order. In an embodiment, the classification associated with each of the plurality of products may be stored as the product classification data 226.

Based on the classification, the quantity parameter determining module 210, of the processing unit 102 may be configured to determine quantity parameter 228 of each of the plurality of products. In an embodiment, for determining the quantity parameter 228 of the product and the one or more components, the predefined values setting module 212 may be configured to initially set the quantity parameters for each of the classification based on the demand factors and volatility factors. In an embodiment, the quantity parameter 228 may be set to be zero for one or more products classified as the make to order. Further, the quantity parameter 228 may be set to be a predefined value 230 for one or more products classified as the assemble to order, based on the demand factors and the volatility factors. In an embodiment, the quantity parameter 228 of products related to same demand and volatility factors may be set to be lesser value when compared to the quantity parameter 228 of products related to low volatility factor, and medium or high demand factor. In an embodiment, the quantity parameter 228 of products related to low volatility factor and medium demand factor may be set to be lesser when compared to the quantity parameter 228 of products related to low volatility factor and high demand factor. Further, the quantity parameter 228 of product associated with medium volatility factor and high demand factor may be retained to same as current state. An exemplary representation of the determined quantity parameters 228 are shown in fifth grid 301E in FIG. 3D. As shown in the fifth grid, the quantity parameters of products classified as make to order is set to be zero. Further, the quantity parameter 228 of products related to same demand and volatility factors is set to be forty-five. The quantity parameter 228 of products related to low volatility factor and medium demand factor is set to be sixty. The quantity parameter 228 of products related to low volatility factor and high demand factor may be set to be ninety. Thus, the quantity parameter 228 of the first product is forty-five, the quantity parameter 228 of the second product is forty-five, the quantity parameter 228 of the third product is zero, the quantity parameter 228 of the fourth product is zero, the quantity parameter 228 of the fifth product is forty-five, the quantity parameter of the sixth product is sixty, the quantity parameter 228 of the seventh product is ninety, the quantity parameter 228 of the eighth product is zero and the quantity parameter 228 of the ninth product is set to be same as the current state of the ninth product.

Further, in an embodiment, the quantity parameter modifying module 214 is configured to modify the determined quantity parameter 228 of the plurality of products based on the current state of the plurality of products. In an embodiment, the current state may indicate quantity of corresponding product exiting in the inventory. The current state of the plurality of products may be represented as sixth grid 301F in FIG. 3E. In an embodiment, the current state may also indicate if a product is associated with inventory build up or with make to stock. Further, the quantity parameter modifying module 214 may be configured to compare the determined quantity parameter 228 with the current state as shown in seventh grid 301G in FIG. 3F. If the difference between the determined quantity parameter and the current state is of a positive value, the quantity parameter modifying module 214 may be configured to modify the quantity parameter 228 to output the modified quantity parameter 232. If the current state is determined to be greater than the quantity parameter 228, the quantity parameter 228 may be modified to be zero. Further, the quantity parameter 228 associated with the current state may be retained to be of the current state. Thus, eighth grid 301H in FIG. 3F shows some of the plurality of products with the modified quantity parameters 232. The modified quantity parameter 232 may be replaced with the determined quantity parameter 228 for managing the inventory of the plurality of products. In an embodiment, one or more 2D grids generated and updated for determining the quantity parameter 228 of the plurality of products may be stored as the grid data 224.

In some non-limiting embodiments or aspects, the processing unit 102 may receive data for managing the inventory via the I/O interface 110. The received data may include, but is not limited to, at least one of the product data 218, the demand pattern data 220, and the like. Also, the processing unit 102 may transmit data for managing the inventory via the I/O interface 110. The transmitted data may include, but is not limited to, the product label data 222, the grid data 224, the product classification data 226, the quantity parameter data 228, the predefined values 230, modified quantity parameter data 232, and the like.

The other data 234 may comprise data, including temporary data and temporary files, generated by modules for performing the various functions of the processing unit 102. The one or more modules 112 may also include other modules 216 to perform various miscellaneous functionalities of the processing unit 102. It will be appreciated that such modules may be represented as a single module or a combination of different modules.

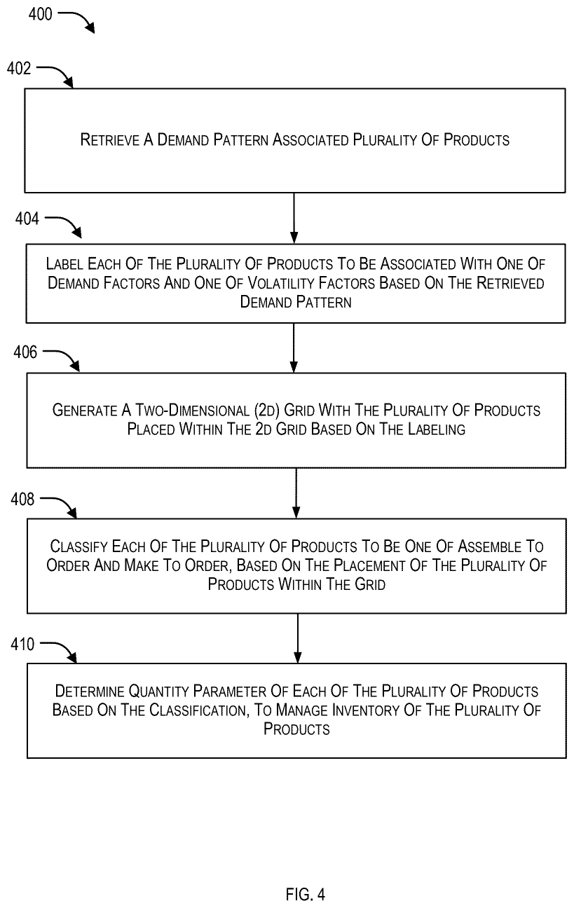

FIG. 4 shows an exemplary process of a processing unit 102 for managing inventory of products with multi-stage manufacturing system, in accordance with an embodiment of the present disclosure. Process 400 for managing the inventory of products includes steps coded in form of executable instructions to be executed by a processing unit 102 associated with the enterprise with one or more products and one or more customers.

At block 402, the processing unit 102 may be configured to receive a demand pattern associated plurality of products. The demand pattern comprises at least one of revenue data and a volatility data associated with each of the plurality of products. In an embodiment, the plurality of products includes an end-product and one or more components associated with the end-product. In an embodiment, the plurality of products are associated with a two-stage manufacturing system. The first stage of the two-stage manufacturing system comprises manufacturing of the one or more components and a second stage of the two-stage manufacturing system comprises assembling the one or more components to output the end-product.

In an embodiment, the revenue data indicates at least one of monetary value and quantity value of sales associated with the plurality of products over a first predefined period of time. In an embodiment, the volatility data indicates risk related to stocking up of the plurality of products in an inventory. The volatility data is computed by dividing standard deviation of a sold quantity of each of the plurality of products with mean of the sold quantity. The sold quantity is measured for a second predefined period of time.

At block 404, the processing unit 102 may be configured to label each of the plurality of products to be associated with one of demand factors and one of volatility factors based on the retrieved demand pattern.

At block 406, the processing unit 102 may be configured to generate a 2D grid with the plurality of products placed within the 2D grid based on the labeling. The 2D grid comprises a dimension associated with the demand factors and another dimension associated with the volatility factors.

At block 408, the processing unit 102 may be configured to classify each of the plurality of products to be one of assemble to order and make to order, based on the placement of the plurality of products within the grid.

At block 410, the processing unit 102 may be configured to determine quantity parameter of each of the plurality of products based on the classification, to manage inventory of the plurality of products. In an embodiment, for determining the quantity parameter of the product and the one or more components, the quantity parameter is set to be zero for one or more products classified as the make to order. Further, the quantity parameter is set to be a predefined value for one or more products classified as the assemble to order, based on the demand factors and the volatility factors.

In an embodiment, the method steps may further include to modify the quantity parameter of at least one of the plurality of products based on current state of the inventory. The quantity parameter may be one of reduced or increased based on the current state.

As illustrated in FIG. 4, the method 400 may include one or more steps for executing processes in the processing unit 102. The method 400 may be described in the general context of computer executable instructions. Generally, computer executable instructions can include routines, programs, objects, components, data structures, procedures, modules, and functions, which perform particular functions or implement particular abstract data types.

The order in which steps in the method 400 are described may not intended to be construed as a limitation, and any number of the described method steps can be combined in any order to implement the method. Additionally, individual steps may be deleted from the methods without departing from the scope of the subject matter described herein. Furthermore, the method can be implemented in any suitable hardware, software, firmware, or combination thereof.

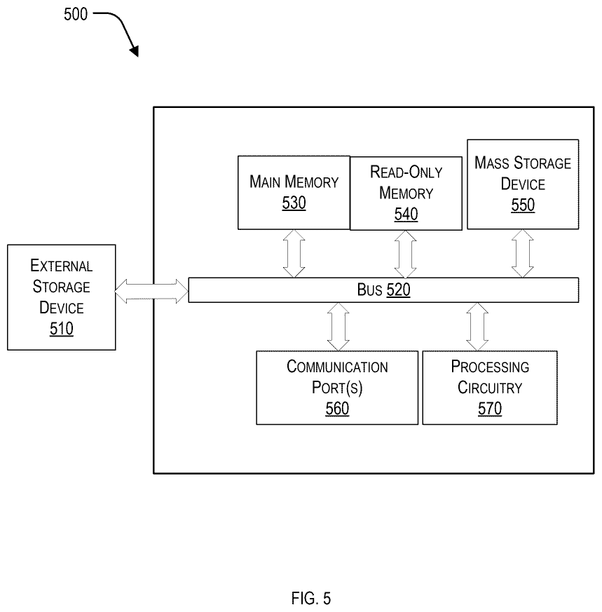

FIG. 5 illustrates an exemplary computer system in which or with which embodiments of the present invention may be utilized. Depending upon the particular implementation, the various process and decision blocks described above may be performed by hardware components, embodied in machine-executable instructions, which may be used to cause a general-purpose or special-purpose processor programmed with the instructions to perform the steps or the steps may be performed by a combination of hardware, software and/or firmware. As shown in FIG. 5, the computer system 500 includes an external storage device 510, bus 520, main memory 530, read-only memory 540, mass storage device 550, communication port(s) 560, and processing circuitry 570.

Those skilled in the art will appreciate that the computer system 500 may include more than one processing circuitry 570 and one or more communication ports 560. The processing circuitry 570 should be understood to mean circuitry based on one or more microprocessors, microcontrollers, digital signal processors, programmable logic devices, Field-Programmable Gate Arrays (FPGAs), Application-Specific Integrated Circuits (ASICs), etc., and may include a multi-core processor (e.g., dual-core, quadcore, Hexa-core, or any suitable number of cores) or supercomputer. In some embodiments, the processing circuitry 570 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the processing circuitry 570 include, but are not limited to, an Intel® Itanium® or Itanium 2 processor(s), or AMD® Opteron® or Athlon MP® processor(s), Motorola® lines of processors, System on Chip (SoC) processors or other future processors. The processing circuitry 570 may include various modules associated with embodiments of the present disclosure.

The communication port 560 may include a cable modem, Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 560 may be any RS-232 port for use with a modem-based dialup connection, a 10/100 Ethernet port, a Gigabit, or a 10 Gigabit port using copper or fiber, a serial port, a parallel port, or other existing or future ports. The communication port 560 may be chosen depending on a network, such as a Local Area Network (LAN), Wide Area Network (WAN), or any network to which the computer system 500 may be connected.

The main memory 530 may include Random Access Memory (RAM) or any other dynamic storage device commonly known in the art. Read-only memory (ROM) 540 may be any static storage device(s), e.g., but not limited to, a Programmable Read-Only Memory (PROM) chips for storing static information, e.g., start-up or BIOS instructions for the processing circuitry 570.

The mass storage device 550 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 530. The mass storage device 550 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 520 communicatively couples the processing circuitry 570 with the other memory, storage, and communication blocks. The bus 520 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processing circuitry 570 to the software system.

Optionally, operator and administrative interfaces, e.g., a display, keyboard, and a cursor control device, may also be coupled to the bus 520 to support direct operator interaction with the computer system 500. Other operator and administrative interfaces may be provided through network connections connected through the communication port(s) 560. The external storage device 510 may be any kind of external hard drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

The computer system 500 may be accessed through a user interface. The user interface application may be implemented using any suitable architecture. For example, it may be a stand-alone application wholly implemented on the computer system 500. The user interfaces application and/or any instructions for performing any of the embodiments discussed herein may be encoded on computer-readable media. Computer-readable media includes any media capable of storing data. In some embodiments, the user interface application is client-server-based. Data for use by a thick or thin client implemented on electronic device computer system 500 is retrieved on-demand by issuing requests to a server remote to the computer system 500. For example, computer system 500 may receive inputs from the user via an input interface and transmit those inputs to the remote server for processing and generating the corresponding outputs. The generated output is then transmitted to the computer system 500 for presentation to the user.

While embodiments of the present invention have been illustrated and described, it will be clear that the invention is not limited to these embodiments only. Numerous modifications, changes, variations, substitutions, and equivalents, will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

What is claimed is:

1. A method for managing inventory of products with multi-stage manufacturing system, the method comprises:
receiving, by a processing unit, a demand pattern associated with plurality of products, wherein the demand pattern comprises at least one of revenue data and a volatility data associated with each of the plurality of products;
labeling, by the processing unit, each of the plurality of products to be associated with one of demand factors and one of volatility factors based on the retrieved demand pattern;
generating, by the processing unit, a Two-Dimensional (2D) grid with the plurality of products placed within the 2D grid based on the labeling, wherein the 2D grid comprises a dimension associated with the demand factors and another dimension associated with the volatility factors;
classifying, by the processing unit, each of the plurality of products to be one of assemble to order and make to order, based on the placement of the plurality of products within the grid; and
determining, by the processing unit, quantity parameter of each of the plurality of products based on the classification, to manage inventory of the plurality of products.

2. The method of claim 1, wherein the revenue data indicates at least one of monetary value and quantity value of sales associated with the plurality of products over a first predefined period of time.

3. The method of claim 1, wherein the volatility data indicates risk related to stocking up of the plurality of products in an inventory, wherein the volatility data is computed by dividing standard deviation of a sold quantity of each of the plurality of products with mean of the sold quantity, wherein the sold quantity is measured for a second predefined period of time.

4. The method of claim 1, further comprising:
setting, by the processing unit, predefined threshold for the demand pattern to define the demand factors and the volatility factors, wherein the demand factors is defined to be low demand, medium demand, and high demand, and the volatility factors is defined to be low volatility, medium volatility and high volatility.

5. The method of claim 1, wherein determining the quantity parameter of the product and the one or more components comprises:
setting the quantity parameter to be zero for one or more products classified as the make to order; and
setting the quantity parameter to be a predefined value for one or more products classified as the assemble to order, based on the demand factors and the volatility factors.

6. The method of claim 5, wherein setting the quantity parameter to be the predefined value for the one or more products classified as the assemble to order comprises:
setting the quantity parameter to be highest for the one or more products labelled as the high demand and the low volatility.

7. The method of claim 1, further comprises:
modifying, by the processing unit, the quantity parameter of at least one of the plurality of products based on current state of the inventory, wherein the quantity parameter may be one of reduced and increased based on the current state.

8. The method of claim 1, wherein the plurality of products comprising an end-product and one or more components associated with the end-product.

9. The method of claim 7, wherein the plurality of products are associated with a two-stage manufacturing system, wherein a first stage of the two-stage manufacturing system comprises manufacturing of the one or more components and a second stage of the two-stage manufacturing system comprises assembling the one or more components to output the end-product.

10. A processing unit for managing inventory of products with multi-stage manufacturing system, the processing unit comprises:
one or more processors; and
a memory communicatively coupled to the one or more processors, wherein the memory stores processor-executable instructions, which, on execution, cause the one or more processors to:
retrieve a demand pattern associated plurality of products, wherein the demand pattern comprises at least one of revenue data and a volatility data associated with each of the plurality of products;
label each of the plurality of products to be associated with one of demand factors and one of volatility factors based on the retrieved demand pattern;
generate a Two-Dimensional (2D) grid with the plurality of products placed within the 2D grid based on the labeling, wherein the 2D grid comprises a dimension associated with the demand factors and another dimension associated with the volatility factors;
classify each of the plurality of products to be one of assemble to order and make to order, based on the placement of the plurality of products within the grid; and
determine quantity parameter of each of the plurality of products based on the classification, to manage inventory of the plurality of products.

11. The processing unit of claim 10, wherein the revenue data indicates at least one of monetary value and quantity value of sales associated with the plurality of products over a first predefined period of time.

12. The processing unit of claim 10, wherein the volatility data indicates risk related to stocking up of the plurality of products in an inventory, wherein the volatility data is computed by dividing standard deviation of a sold quantity of each of the plurality of products with mean of the sold quantity, wherein the sold quantity is measured for a second predefined period of time.

13. The processing unit of claim 10, further comprises the processing unit configured to:
set predefined threshold for the demand pattern to define the demand factors and the volatility factors, wherein the demand factors is defined to be low demand, medium demand, and high demand and the volatility factors is defined to be low volatility, medium volatility, and high volatility.

14. The processing unit of claim 10, wherein the processing unit is configured to determine the quantity parameter of the product and the one or more components by:
setting the quantity parameter to be zero for one or more products classified as the make to order; and
setting the quantity parameter to be a predefined value for one or more products classified as the assemble to order, based on the demand factors and the volatility factors.

15. The processing unit of claim 14, wherein the processing unit is configured to set the quantity parameter to be the predefined value for the one or more products classified as the assemble to order by:
setting the quantity parameter to be highest for the one or more products labelled as the high demand and the low volatility.

16. The processing unit of claim 10, the processing unit is further configured to:
modify the quantity parameter of at least one of the plurality of products based on current state of the inventory, wherein the quantity parameter may be one of reduced and increased based on the current state.

17. The processing unit of claim 10, wherein the plurality of products comprising an end-product and one or more components associated with the end-product.

18. The processing unit of claim 10, wherein the plurality of products are associated with a two-stage manufacturing system, wherein a first stage of the two-stage manufacturing system comprises manufacturing of the one or more components and a second stage of the two-stage manufacturing system comprises assembling the one or more components to output the end-product.

19. A non-transitory computer-readable medium including instructions stored thereon that when processed by one or more processors cause a system to perform operations comprising:
receiving a demand pattern associated plurality of products, wherein the demand pattern comprises at least one of revenue data and a volatility data associated with each of the plurality of products;
labeling each of the plurality of products to be associated with one of demand factors and one of volatility factors based on the retrieved demand pattern;
generating, by the processing unit, a Two-Dimensional (2D) grid with the plurality of products placed within the 2D grid based on the labeling, wherein the 2D grid comprises a dimension associated with the demand factors and another dimension associated with the volatility factors;
classifying each of the plurality of products to be one of assemble to order and make to order, based on the placement of the plurality of products within the grid; and
determining quantity parameter of each of the plurality of products based on the classification, to manage inventory of the plurality of products.
